(19) United States
(12) Patent Application Publication
(10) Pub. No.: US 2026/0260304 A1
(43) Pub. Date: Sep. 3, 2026

(54) DISH RECOMMENDATION SYSTEM, DISH RECOMMENDATION METHOD, AND PROGRAM

(71) Applicant: Panasonic Intellectual Property Management Co., Ltd., Osaka (JP)

(72) Inventor: Isao UEDA, Osaka (JP)

(21) Appl. No.: 18/865,943

(22) PCT Filed: Mar. 15, 2024
(86) PCT No.: PCT/JP2024/010216

§ 371 Date: Nov. 14, 2024

(30) Foreign Application Priority Data
Mar. 28, 2023 (JP) 2023-051620

(51) Int. Cl. G06Q 50/12

(52) U.S. Cl. CPC G06Q 50/12

(57) ABSTRACT

Dish recommendation system including: an acquiring unit that acquires, in advance, items of event data obtained by classifying, by dish type information, identification information of dishes eaten by a user, dish type information including taste sensation information for classifying dishes by taste sensation, and meal time information; an extracting unit performing time-series association analysis to calculate a plurality of characteristic indexes including at least one of a degree of support, a confidence level, and a lift value relating to the user's eating habits, by dish type information, on the basis of the items of event data, and extracts a specific characteristic index obtained by analyzing characteristics of the user's eating habits, from the characteristic indexes, based on the specific event data corresponding to dish type information input by the user; and a recommendation unit for outputting a dish candidate for the user on the basis of the specific characteristic index.

### TECHNICAL FIELD

The present disclosure dish recommendation system, dish recommendation method and program.

### BACKGROUND ART

In the related art, a dish recommendation system that suggests dishes based on the use's meal history has been suggested. For example, PTL 1 discloses a device that suggests dishes to be eaten next by using meal patterns, preferences, food amounts and the like based on past meal histories.

### CITATION LIST

### Patent Literature

### PTL 1

Japanese Patent Application Laid-Open No. 2022-124701

### SUMMARY OF INVENTION

### Technical Problem

However, since the device in PTL 1 automatically suggests dishes without confirming the user's requests, there was a risk that dishes different from what the user wanted to eat would be suggested.

An object of the present disclosure is to provide a dish recommendation system, a dish recommendation method and a program for suggesting appropriate dishes to the user.

### Solution to Problem

A dish recommendation system according to the present disclosure includes: an acquirer that acquires in advance a plurality of pieces of event data obtained by dividing, by dish type information, dish identification information on a dish a user has eaten, dish type information including taste sensation information that classifies the dish by taste sensation, and meal time information; an extractor that extracts a specific characteristic index obtained by analyzing characteristics of eating habits of the user from a plurality of characteristic indices based on specific event data corresponding to specific dish type information input from the user, by calculating the plurality of characteristic indices through time-series association analysis for each dish type information based on the plurality of pieces of event data, the plurality of characteristic indices including at least one of a support level, a probability level and a lift value related to the eating habits of the user; and a recommender that outputs a dish candidate to be suggested to the user based on the specific characteristic index.

A dish recommendation method according to the present disclosure includes: acquiring in advance a plurality of pieces of event data obtained by dividing, by dish type information, dish identification information on a dish a user has eaten, dish type information including taste sensation information that classifies the dish by taste sensation, and meal time information; extracting a specific characteristic index obtained by analyzing characteristics of eating habits of the user from a plurality of characteristic indices based on specific event data corresponding to specific dish type information input from the user, by calculating the plurality of characteristic indices through time-series association analysis for each dish type information based on the plurality of pieces of event data, the plurality of characteristic indices including at least one of a support level, a probability level and a lift value related to the eating habits of the user; and outputting a dish candidate to be suggested to the user based on the specific characteristic index.

A program according to the present disclosure causes a computer to execute: acquiring in advance a plurality of pieces of event data obtained by dividing, by dish type information, dish identification information on a dish a user has eaten, dish type information including taste sensation information that classifies the dish by taste sensation, and meal time information; extracting a specific characteristic index obtained by analyzing characteristics of eating habits of the user from a plurality of characteristic indices based on specific event data corresponding to specific dish type information input from the user, by calculating the plurality of characteristic indices through time-series association analysis for each dish type information based on the plurality of pieces of event data, the plurality of characteristic indices including at least one of a support level, a probability level and a lift value related to the eating habits of the user; and outputting a dish candidate to be suggested to the user based on the specific characteristic index.

### Advantageous Effects of Invention

According to the present disclosure, appropriate dishes can be suggested to the user.

### BRIEF DESCRIPTION OF DRAWINGS

FIG. 1 is a diagram illustrating an overview of an embodiment of the present disclosure;

FIG. 2 is a block diagram illustrating a functional configuration of a dish recommendation system according to the embodiment of the present disclosure;

FIG. 3 is a block diagram illustrating a hardware configuration of a dish recommendation system according to the embodiment of the present disclosure;

FIG. 4 is a flowchart illustrating an operation of the embodiment of the present disclosure;

FIG. 5 is a diagram illustrating dish type information determined on the basis of ingredient information;

FIG. 6 is a diagram illustrating event data;

FIG. 7 is a diagram illustrating analysis data obtained through time-series association analysis on event data of the user;

FIG. 8 is a diagram illustrating analysis data obtained by normalizing a characteristic index;

FIG. 9 is a diagram illustrating a state where time-series association analysis is performed on event data of another user;

FIG. 10 is a diagram illustrating comparison data obtained by comparing characteristic indices of the user and another user;

FIG. 11 is a diagram illustrating suggestion data including dish candidates output from a recommender; and

FIG. 12 is a diagram illustrating eating habit data output from the recommender.

### DESCRIPTION OF EMBODIMENTS

Embodiments of the present disclosure are described below with reference to the

### DRAWINGS

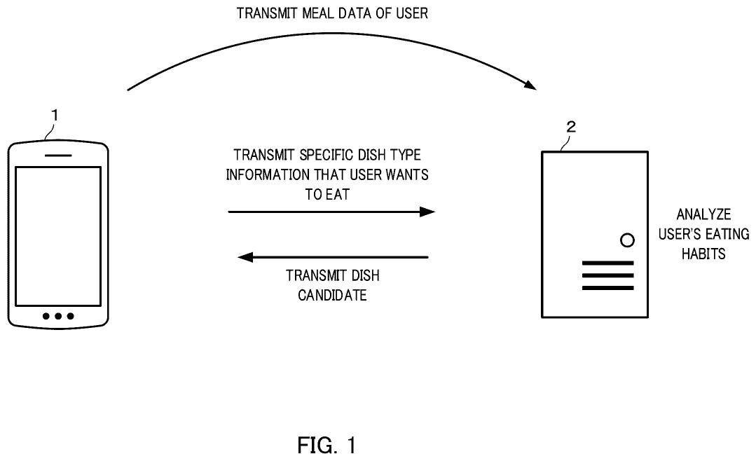

An overview of the present disclosure is described below. For example, as illustrated in FIG. 1, when user's meal data (e.g. images of foods, etc.) is input, user terminal 1 sequentially transmits the meal data to server 2. Here, server 2 includes the dish recommendation system of the present disclosure. When receiving meal data from terminal 1, the dish recommendation system of server 2 acquires the identification information (e.g. name, etc.) of the dish the user has eaten, the dish type information (e.g. refreshing, etc.) and the meal time information (e.g. date, etc.) on the basis of the meal data, and creates in advance a plurality of pieces of event data by dividing the information by dish type information. Then, the dish recommendation system analyzes the characteristics of the user's eating habits on the basis of the event data. At this time, analysis of the user's eating habits on the basis of the event data including only the dish identification information and the meal time information results in analysis of the eating habits including various types of food, and as such it is difficult to analyze the eating habits on the basis of the dish type such as the eating habits of “refreshing” dish. In view of this, when specific dish type information that the user wants to eat (e.g. refreshing, etc.) is input to terminal 1, terminal 1 transmits the specific dish type information to server 2. When receiving the specific dish type information from terminal 1, the dish recommendation system of server 2 extracts a characteristic index obtained by analyzing the characteristics of the user's eating habits on the basis of the specific event data corresponding to the specific dish type information. Then, the dish recommendation system outputs the dish candidate to be suggested to the user on the basis of the extracted characteristic index, and transmits the dish candidate to terminal 1. In this manner, terminal 1 displays on the display the dish candidate corresponding to the specific dish type information.

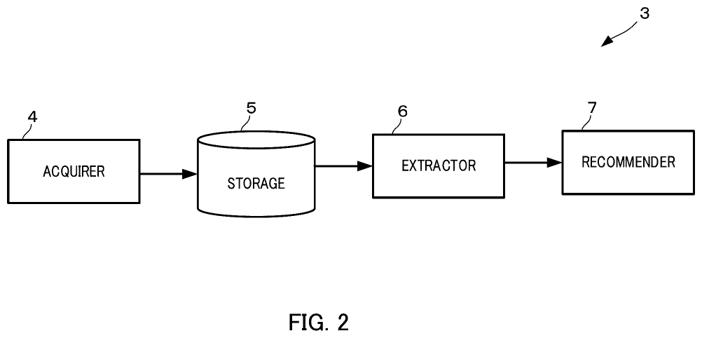

Next, a configuration of the dish recommendation system according to the present disclosure is elaborated. As illustrated in FIG. 2, dish recommendation system 3 includes acquirer 4, storage 5, extractor 6, and recommender 7. Acquirer 4 is connected to storage 5, and storage 5 is connected to recommender 7 through extractor 6.

Acquirer 4 acquires a plurality of pieces of event data obtained by dividing by the dish type information the identification information on the dish the user has eaten, the dish type information, and the meal time information. Here, the dish may include a single dish (e.g. hamburg steak, etc.), a menu showing a plurality of dishes (e.g. rice and hamburg steak, etc.) and the like. In addition, examples of the dish identification information include the name of the dish, identification number and the like. In addition, the dish type information is information for classifying dishes by the type, and may include the taste sensation information that classifies the dishes by the taste sensation, for example. Examples of the taste sensation information include texture information indicating the physical taste sensation, taste information indicating chemical taste sensation and the like. More specifically, the taste sensation information may include onomatopoeia information representing the taste sensation, more specifically information representing mimetic words or sound-mimetic words. Examples of the onomatopoeia include light, rich, plump, lumpy, dusty, crunchy, syrupy and the like. Here, the onomatopoeia information may be composed of at least a part of the character string making up the onomatopoeia. In addition, the meal time information is information related to the meal time, such as meal time, date, time period (e.g. breakfast, lunch, and dinner) and the like.

For example, acquirer 4 may receive the meal data input by the user from terminal 1. Here, the meal data is data related to the dish the user has eaten, and may include images of foods (photograph, etc.), menu, questionnaire about dishes (e.g., preference information on dishes, avoided ingredient information, the user attribute information, etc.), dish type information and the like, for example. The preference information on dishes is information related to dishes that the user prefers, and may include dish name or ingredient name that the user prefers and the like, for example. In addition, the avoided ingredient information is information related to the ingredient avoided by the user for the dishes, and may be ingredients that users dislike or have allergic reactions to and the like, for example. In addition, the user attribute information may include gender, whether or not the user is on a diet, and whether or not the user has a pre-existing medical condition (e.g., high blood pressure). When receiving the meal data, acquirer 4 acquires the identification information on the dish the user has eaten, the dish type information, and the meal time information on the basis of the meal data, and creates a plurality of pieces of event data obtained by dividing the information by dish type information.

Storage 5 stores a plurality of pieces of event data acquired by acquirer 4. Specifically, storage 5 stores the plurality of pieces of event data obtained by dividing by the dish type information the identification information on the dish the user has eaten and the meal time information in association with each other. In addition, storage 5 outputs to extractor 6 the specific event data corresponding to the specific dish type information input from the user among the plurality of pieces of event data. For example, when acquirer 4 receives from terminal 1 the specific dish type information input to terminal 1 by the user, storage 5 may output to extractor 6 the specific event data corresponding to the specific dish type information. For example, when the specific taste sensation information “refreshing” is input as the specific dish type information from the user, storage 5 may output to extractor 6 event data corresponding to the “refreshing”.

Through time-series association analysis, extractor 6 calculates a plurality of characteristic indices including at least one of the support level, the probability level and the lift value related to the user's eating habits for each dish type information on the basis of the plurality of pieces of event data. Then, extractor 6 extracts from among the plurality of characteristic indices the characteristic index obtained by analyzing the characteristics of the user's eating habits on the basis of the specific event data input from storage 5. Here, the characteristics of the eating habits may represent the tendency of the user's dish selection (e.g. rule or condition, etc.) in multiple dishes, and may indicate the tendency of the user's dish selection for three “refreshing” dishes, for example. In addition, the characteristic index indicates the characteristics of the eating habits, and may be calculated through comparison of the event data of multiple dishes, for example.

On the basis of the characteristic index acquired by extractor 6, recommender 7 outputs the dish candidate to be suggested to the user. At this time, recommender 7 may output the dish candidate on the basis of the event data that satisfies at least one condition of a support level equal to or greater than the predetermined threshold value, a probability level equal to or greater than the predetermined threshold value, and a lift value equal to or greater than the predetermined threshold value. In addition, on the basis of a plurality of pieces of event data obtained by dividing by the dish type information the identification information of the food the other user has eaten, the dish type information, and the meal time information, recommender 7 may analyze the characteristics of the other user's eating habits for each dish type information. Then, recommender 7 may search for the dish candidate to be suggested to the user on the basis of the characteristic index of the user calculated by extractor 6 and the characteristic index of the other user corresponding to the specific dish type information.

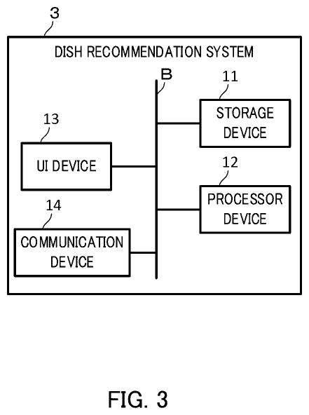

FIG. 3 illustrates a hardware configuration of dish recommendation system 3.

Dish recommendation system 3 includes storage device 11, processor device 12, user interface (UI) device 13, and communication device 14, which are connected to each other through bus B.

Note that, the programs or instructions for implementing various functions and processes described later in dish recommendation system 3 may be downloaded from a given external device through network, or may be provided from a detachable storage medium such as a CD-ROM (Compact Disk-Read Only Memory) and a flash memory.

Storage device 11 is implemented by one or more non-transitory storage mediums (non-transitory storage mediums) such as a random access memory, a flash memory, and a hard disk drive, and stores files, data and the like used for executing programs or instructions together with installed programs or instructions, for example.

Processor device 12 may be implemented by one or more GPUs (Graphics Processing Units), processing circuits (processing circuitry) and CPUs (Central Processing Unit) that may be composed of one or more processor device cores. Processor device 12 executes various functions and processes of dish recommendation system 3 described later in accordance with the data such as programs, instructions, parameters required for executing the programs or instructions stored in storage device 11.

UI device 13 may be composed of input devices such as keyboard, mouse, camera, and microphone, output devices such as display, speaker, headset, and printer, or input/output devices such as smart phone, tablet, and touch panel, and implements the interface between the administrator and the food recommendation system 3. For example, the administrator may operate the food recommendation system 3 by manipulating the graphical user interface (GUI) displayed on the display or touch panel using a keyboard, mouse, and the like.

Note that, the above-described hardware configuration is merely an example, and dish recommendation system 3 according to the present disclosure may be implemented by other appropriate hardware configurations.

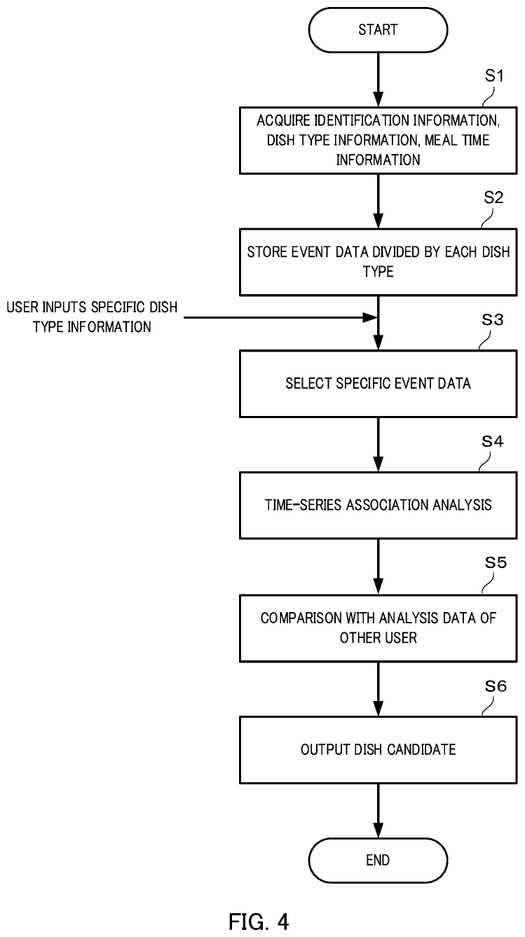

Next, an operation of the present embodiment is described with reference to the flowchart illustrated in FIG. 4.

First, at step S1, acquirer 4 of dish recommendation system 3 illustrated in FIG. 2 acquires event data including the identification information on the dish the user has eaten, the dish type information, and the meal time information. For example, acquirer 4 may acquire the event data on the basis of the meal data of the user. For example, when the user inputs to terminal 1 meal data such as a captured image of a dish eaten, terminal 1 sequentially transmits the meal data to server 2. Then, when receiving the meal data of the user from terminal 1, acquirer 4 of dish recommendation system 3 at server 2 acquires the identification information on the dish the user has eaten, the dish type information, and the meal time information on the basis of the meal data. At this time, acquirer 4 may further acquire the ingredient information on the dish the user has eaten on the basis of the meal data. Note that, the ingredient information is information on ingredients used in the dish, and may include information on ingredients (e.g., radish, carrots, etc.), seasonings (e.g., soy sauce, miso, etc.), and quantity of ingredients, for example.

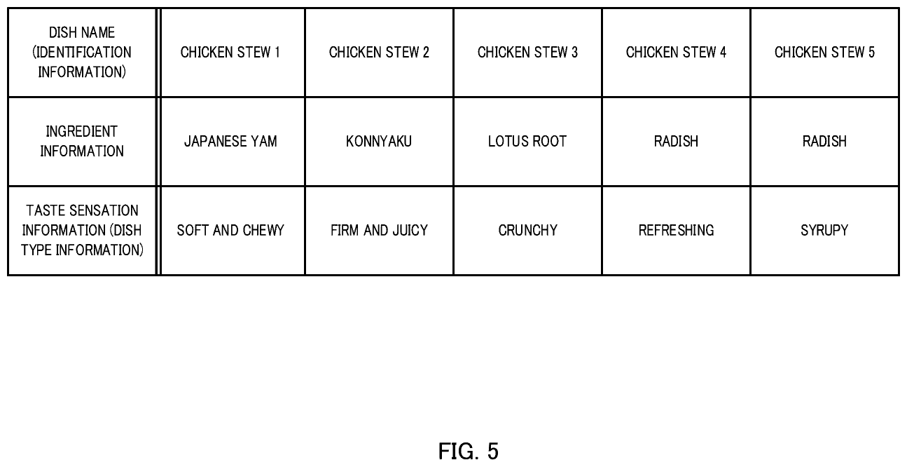

For example, acquirer 4 may recognize the name (identification information) and the ingredient information on the dish the user has eaten on the basis of the captured image of the dish received as meal data, and estimate the taste sensation information (dish type information) that classifies the dishes by the taste sensation on the basis of the ingredient information. For example, as illustrated in FIG. 5, even when the same dishes as chicken stew 1 to chicken stew 5 are recognized, acquirer 4 may recognize differences in the ingredient information on chicken stews 1 to 5, and estimate taste sensation information on the basis of the ingredient information. For example, when acquirer 4 recognizes that the ingredient information on chicken stew 1 is Japanese yam on the basis of a captured image of chicken stew 1, acquirer 4 may estimate that the taste sensation information is “soft and chewy” on the basis of the texture of the Japanese yam. Note that, the ingredient information of chicken stew 4 and chicken stew 5 is indicated as “radish”, but it may be classified as “refreshing” and “syrupy” on the basis of other ingredients. Specifically, the taste sensation information may be comprehensively estimated from information on a plurality of ingredients used in the dish. In addition, acquirer 4 may acquire the meal time information on the basis of the capturing time associated with the meal data received from terminal 1, for example.

Note that, in the above-mentioned embodiment, acquirer 4 acquires the identification information on the dish the user has eaten, the dish type information, the meal time information, and the ingredient information on the basis of the meal data of the user, but this is not limitative as long as the above-described information can be acquired. For example, acquirer 4 may directly acquire from terminal 1 the identification information on the dish the user has eaten, the dish type information, the meal time information, and the ingredient information. Specifically, terminal 1 may receive the input of the identification information on the dish the user has eaten, the dish type information, the meal time information, and the ingredient information from the user, and transmit to server 2 the dish identification information, the dish type information, the meal time information, and the ingredient information input from the user.

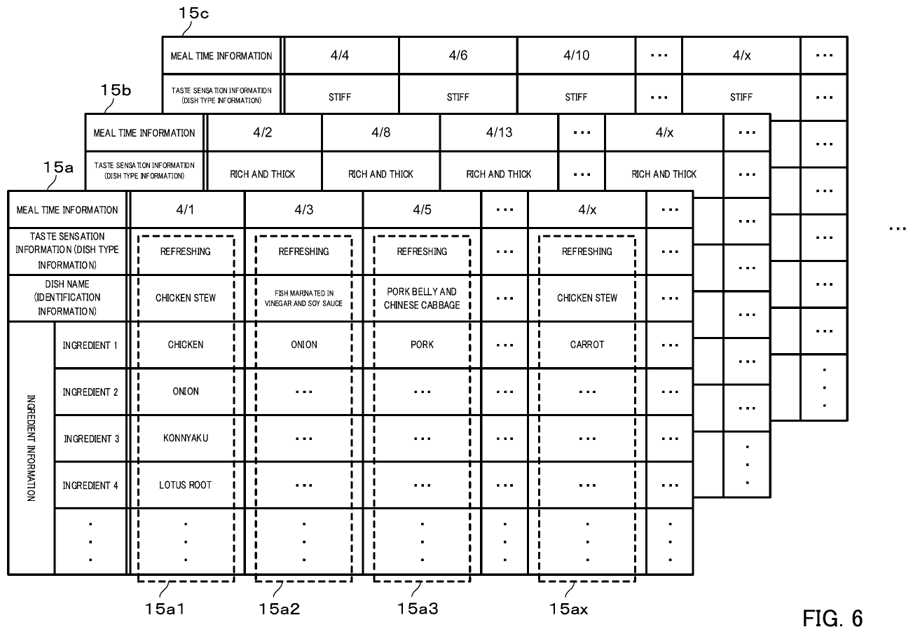

Subsequently, at step S2, acquirer 4 creates a plurality of pieces of event data obtained by dividing by dish type information the acquired dish identification information, the dish type information and the meal time information, and stores the event data in storage 5. At this time, acquirer 4 may store in storage 5 a plurality of pieces of event data in which at least one of the dish the user has eaten and the ingredient information, and the dish type information are associated with each other. For example, as illustrated in FIG. 6, acquirer 4 may create a plurality of pieces of event data 15a, 15b . . . obtained by dividing the name of the dish (identification information), the taste sensation information (dish type information) and the meal time information, by the taste sensation information “refreshing”, “rich and thick” . . . . More specifically, when acquirer 4 acquires data on April 1, it records that data in event data 15a on the basis of the taste sensation information “refreshing”, and when it acquires data on April 2, it records that data in event data 15b on the basis of the taste sensation information “rich and thick”. In addition, acquirer 4 may create the plurality of pieces of event data 15a, 15b . . . in which the name of the dish the user has eaten, the taste sensation information and the ingredient information are associated with each other for each date of the meal time information, and store the plurality of pieces of event data 15a, 15b . . . in storage 5. In this manner, in the plurality of pieces of event data 15a, 15b . . . , the data of the same taste sensation information is recorded and arranged in the order of the meal time. Acquirer 4 updates event data 15a, 15b . . . each time the meal data of the user is received, and constructs the plurality of pieces of event data 15a, 15b . . . related to the dish the user has eaten in the past.

On the other hand, terminal 1 may receive from the user a suggestion request of the dish that the user will now prepare. In this case, terminal 1 may receive the input of the specific dish type information. For example, terminal 1 may receive specific taste sensation information that classifies the dish by the taste sensation. In this case, terminal 1 may receive the onomatopoeia information representing the taste sensation as the taste sensation information. When the specific dish type information is input from the user, terminal 1 transmits the specific dish type information to server 2. Here, it is assumed that the user has input the onomatopoeia “refreshing” into terminal 1 as the specific taste sensation information.

In this manner, the dish type information includes the taste sensation information that classifies the dishes by the taste sensation. For example, when a dish is classified on the basis of food culture such as “French cuisine”, such a dish includes various types of food (e.g. “refreshing” dishes and “rich and thick” dishes), and consequently it is difficult to appropriately indicate the dishes desired by the user. In view of this, the user can appropriately designate the desired dish range by designating the dish type by the taste sensation information. In addition, the taste sensation information includes onomatopoeia information representing the taste sensation. As such, the user can easily designate the taste sensation information.

In dish recommendation system 3 of server 2, when receiving the specific taste sensation information “refreshing” input by the user from terminal 1, extractor 6 at step S3 selects specific event data 15a corresponding to the specific taste sensation information “refreshing” from among the plurality of pieces of event data 15a, 15b . . . stored in storage 5. At this time, extractor 6 may select data of a predetermined period (e.g. 14 days) among specific event data 15a. Then, at step S4, extractor 6 may calculate the characteristic index indicating the user's eating habits through time-series association analysis on extracted specific event data 15a. Examples of the characteristic index include the support level, the probability level and the lift value and the like for the combinations of events, for example. For example, extractor 6 may calculate the characteristic index including at least one of the support level, the probability level and the lift value. Note that, extractor 6 may automatically calculate the characteristic index for each dish type information on the basis of the plurality of pieces of event data 15a, 15b . . . stored in storage 5 without receiving the specific taste sensation information from the user.

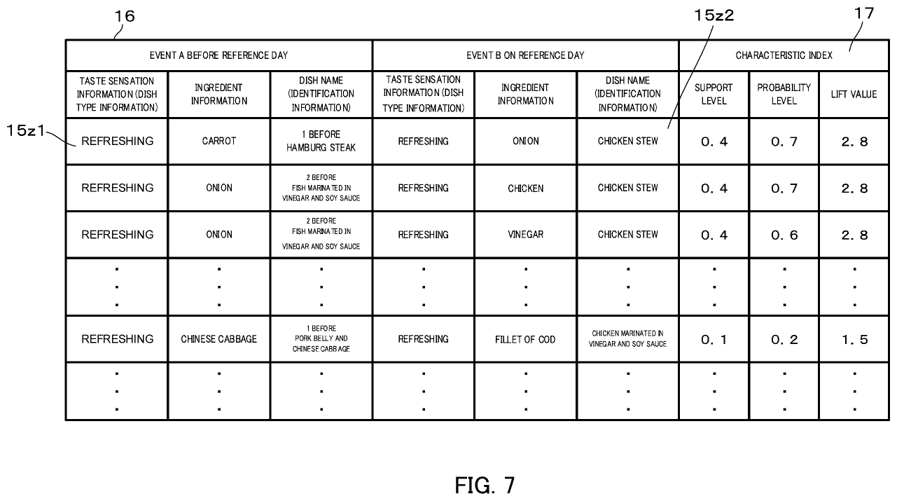

More specifically, as illustrated in FIG. 6, when extractor 6 recognizes the name of the dish, the taste sensation information and the ingredient information as event data 15a1, event data 15a2, . . . for each line (e.g. per day) in specific event data 15a of 14 days (predetermined period), it may calculate the characteristic index on the basis of a combination of two event data included in a predetermined analysis period (e.g. 3 days). For example, when April 10 is set as the reference day, extractor 6 sets the three days, April 10, April 8 (one before), and April 5 (two before), as the analysis period, and calculates the characteristic index for the combination of the two event data included in the analysis period. For example, as illustrated in FIG. 7, extractor 6 calculates characteristic index 17 for all combinations of event data 15z1 corresponding to event A (event on April 8 or April 5) before the reference day, and event data 15z2 corresponding to event B on the reference day (event on April 10). Subsequently, when the reference day is shifted by one and set to April 8, extractor 6 sets the three days, April 8, April 5 (one before), and April 3 (two before), as the next analysis period, and calculates characteristic index 17 for all combinations of two pieces of event data 15z1 and 15z2 included in the analysis period. In this manner, extractor 6 calculates characteristic index 17 on the basis of the combination of two pieces of event data 15z1 and 15z2 included in each analysis period while sequentially shifting the analysis period within 14 days (predetermined period). Then, extractor 6 generates analysis data 16 of 14 days (predetermined period) including event data 15z1 of event A, event data 15z2 of event B, and characteristic index 17.

Here, the support level may represent the number of combinations of event data 15z1 of event A and event data 15z2 of event B, and may be calculated by the following Equation (1), for example. In addition, the probability level may represent the probability of eating the dish of event A one or two before eating the dish of event B, and may be calculated by the following Equation (2). In addition, the lift value may represent the degree of increase in the probability of eating the dish of event A one or two before eating the dish of event B, and may be calculated on the basis of the following Equation (3), for example. Note that, the total number of data may be calculated by the number of pieces of dish identification information×the number of pieces of dish type information×the number of pieces of ingredient information×the number of analysis periods (e.g. 3), for example.

$$Support level = the number of data in which event data 15 z 1 of event A and event data 15 z 2 of event B indicate the same combination \div the total number of data \qquad ( 1 )$$

$$Probability level = the number of data in which event data 15 z 1 of event A and event data 15 z 2 of event B indicate the same combination \div the number of data including event data 15 z 2 of event B \qquad ( 2 )$$

$$Lift value = the number of data in which event data 15 z 1 of event A and event data 15 z 2 of event B indicate the same combination \div the number of data including event data 15 z 2 of event B \div the number of data including event data 15 z 1 of event A \div the total number of data \qquad ( 3 )$$

At this time, extractor 6 may search for analysis data 16a on the basis of the temporal order of event data 15a1, 15a2, . . . in specific event data 15a, and filter and remove the data of the order that is not included in specific event data 15a. For example, in the case where event data 15z2 (corresponding to event B) is recorded after event data 15z1 (corresponding to event A) in specific event data 15a, extractor 6 may filter and remove the data with event A representing event data 15z2 and event B representing event data 15z1 (data with the reverse order of specific event data 15a) in analysis data 16a. In this manner, specific event data 15a is subjected to association analysis in a time-series manner.

In this manner, on the basis of specific event data 15a corresponding to the specific dish type information “refreshing” input by the user, extractor 6 extracts characteristic index 17 obtained by analyzing the characteristics of the user's eating habits. At this time, in the plurality of pieces of event data 15a, 15b . . . , information on the dish the user has eaten is divided for each dish type information, and thus extractor 6 can easily extract the characteristics of the user's eating habits by only analyzing specific event data 15a corresponding to the specific dish type information.

In addition, extractor 6 analyzes the characteristics of the eating habits of user P through time-series association analysis on specific event data 15a, and outputs characteristic index 17 such as the support level, the probability level and the lift value. In this manner, extractor 6 can correctly indicate the eating habits of user P with characteristic index 17.

In addition, the plurality of pieces of event data 15a, 15b . . . includes information on the ingredient of the dish eaten by user P. In this manner, extractor 6 can more correctly analyze the characteristics of the eating habits of user P on the basis of the difference in ingredient information.

In addition, the plurality of pieces of event data 15a, 15b . . . is composed of at least one of the dish eaten by user P and the ingredient information and the dish type information that are associated with each other. In this manner, extractor 6 can easily analyze the characteristics of the eating habits of user P.

In addition, the dish type information includes the taste sensation information that classifies the dishes by the taste sensation. Extractor 6 performs the analysis on the basis of the taste sensation information that has a significant influence on the user's eating habits, and therefore can correctly analyze the characteristics of the eating habits of user P. In addition, the taste sensation information includes onomatopoeia information representing the taste sensation. Extractor 6 performs analysis on the basis of the onomatopoeia accurately representing the taste sensation information, and therefore can more correctly analyze the characteristics of the eating habits of user P.

Note that, extractor 6 may extract characteristic index 17 by further using at least one of the preference information and the avoided ingredient information of user P. For example, extractor 6 may search for analysis data 16 on the basis of the preference information of user P, and may preferentially extract event data including characteristic index 17 in which the dish or ingredient corresponding to the preference information is registered. In addition, extractor 6 may search for analysis data 16 on the basis of avoided ingredient information of user P, may extract event data including characteristic index 17 in which the avoided ingredient information is not registered. Specifically, extractor 6 may delete from analysis data 16 the event data in which the avoided ingredient information is registered. Note that, the preference information and the avoided ingredient information may be calculated on the basis of the meal data of user P, or may be set by user P. In this manner, extractor 6 can appropriately extract characteristic index 17 in accordance with the preference information or the avoided ingredient information of user P.

In addition, extractor 6 may extract characteristic index 17 by further using the attribute information of user P. For example, when the attribute information of user Pis set as being on a diet, extractor 6 may extract event data of dishes with calories equal to or smaller than a predetermined value. Note that the attribute information may be set by user P.

In addition, extractor 6 may extract characteristic index 17 by further using recipe viewing history. For example, when user P searches the Web for a recipe for a dish, terminal 1 may transmit its recipe viewing information to server 2. Extractor 6 may calculate the preference information of user P on the basis of the recipe viewing history sent from terminal 1. Then, extractor 6 may preferentially extract event data including characteristic index 17 in which the dish or ingredient corresponding to the calculated preference information of user P is registered.

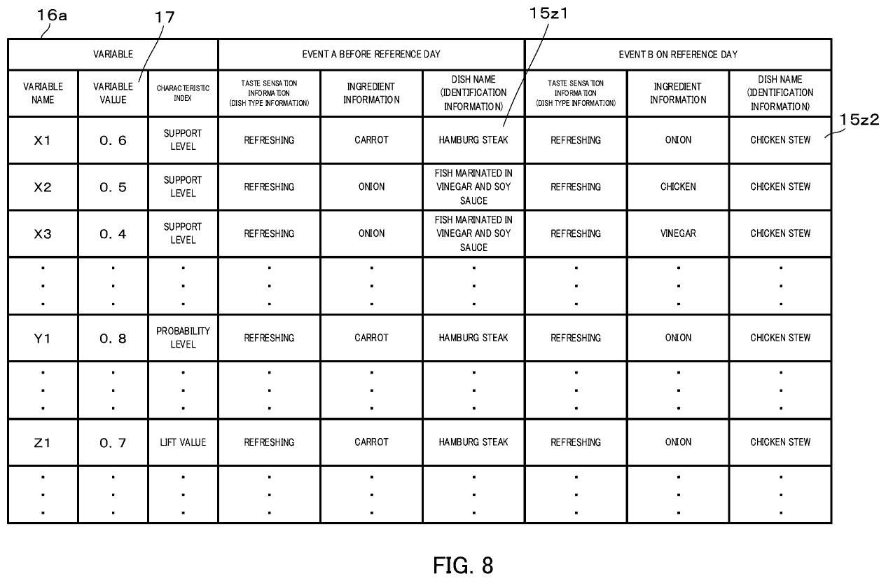

In addition, extractor 6 may normalize the characteristic index. For example, as illustrated in FIG. 8, extractor 6 may create analysis data 16a representing a variable value obtained by normalizing the support level, the probability level and the lift value of characteristic index 17. Note that the variable name is a name representing a combination of event data 15z1 of event A and event data 15z2 of event B. Here, variable names X, Y and Z represent the same combinations of event data 15z1 of event A and event data 15z2 of event B with respective support levels (X1, X2 . . . ), probability levels (Y1, . . . ) and lift values (Z1, . . . ).

Subsequently, extractor 6 outputs analysis data 16 including the extracted characteristic index 17 to recommender 7. Here, it is assumed that extractor 6 has output analysis data 16a to recommender 7. When analysis data 16a is input, recommender 7 compares analysis data obtained through time-series association analysis on the characteristics of the other user's eating habits, with analysis data 16a of the user at step S5. Here, on the basis of a plurality of pieces of event data obtained by dividing by the dish type information the identification information of the food the other user has eaten, the dish type information, and the meal time information, recommender 7 may analyze the characteristics of the other user's eating habits for each dish type information as with the user, and may store the plurality of pieces of analysis data in advance in the storage.

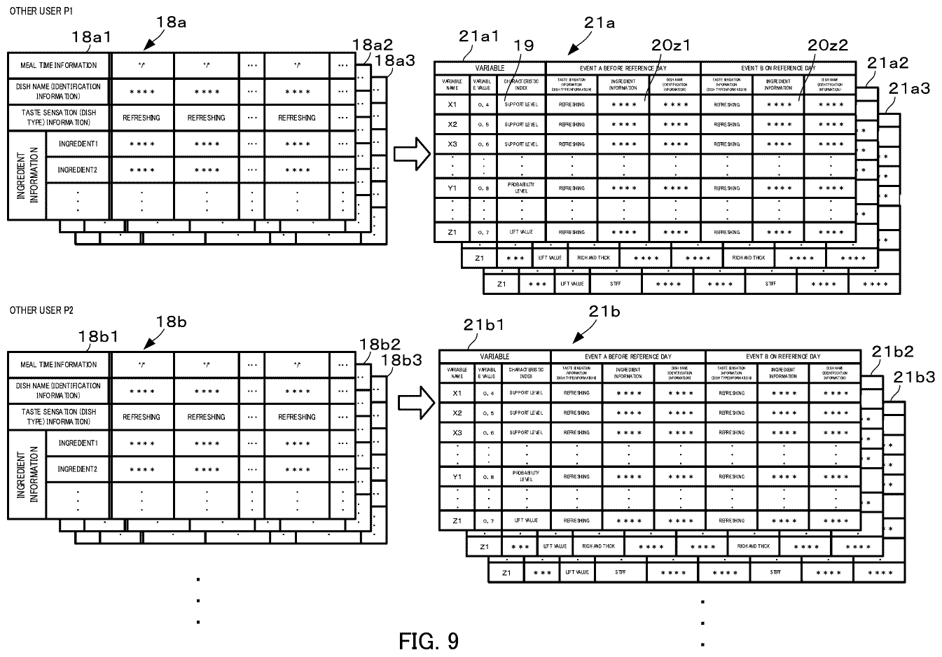

For example, as illustrated in FIG. 9, recommender 7 acquires in advance event data 18a, 18b, . . . of a plurality of other users P1, P2, . . . . At this time, recommender 7 may create a plurality of pieces of event data obtained by dividing by dish type information the dish identification information, the dish type information and the meal time information for each of other users P1, P2, . . . . For other user P1, for example, recommender 7 may create a plurality of pieces of event data 18a1, 18a2 . . . obtained by dividing, by the taste sensation information “refreshing”, “rich and thick” . . . , the identification information, the taste sensation information and the meal time information on the dish eaten by other user P1. Then, recommender 7 analyzes the characteristics of the other user's eating habits by the taste sensation information “refreshing”, “rich and thick” . . . on the basis of event data 18a1, 18a2 . . . . At this time, recommender 7 may calculate characteristic index 19 indicating the other user's eating habits through time-series association analysis on event data 18a1, 18a2 . . . . In this manner, recommender 7 generates analysis data 21a1, 21a2 . . . each including event data 20z1 of event A, event data 20z2 of event B, and characteristic index 19. Then, analysis data 21a1, 21a2 . . . is each generated so as to correspond to the taste sensation information “refreshing”, “rich and thick” . . . . Likewise, recommender 7 calculates characteristic index 19 representing the eating habits also for other users P2, P3 . . . , and generates analysis data 21b, 21c . . . including event data 20z1 of event A, event data 20z2 of event B, and characteristic index 19. Recommender 7 stores analysis data 21a, 21b . . . of other users P1, P2, . . . in advance in the storage.

Note that, when variable names do not coincide with each other between other users P1, P2, . . . (when a variable name of a specific user is missing), recommender 7 may complement the missed variable name of the specific user on the basis of the average value of the variable value and the like of other users P1, P2, . . . having a variable name. In addition, recommender 7 may acquire from extractor 6 the preference information, the avoided ingredient information, the attribute information, or the recipe viewing history of user P, and may extract characteristic index 19 by using the above-described information as with extractor 6. For example, between step S5 and step S6, recommender 7 may perform filtering of analysis data 21a, 21b . . . on the basis of the preference information, the avoided ingredient information, the attribute information, or the recipe viewing history of user P.

When analysis data 16a of the user representing the taste sensation information “refreshing” is input from extractor 6, recommender 7 selects analysis data 21a1, 21b1, . . . corresponding to the taste sensation information “refreshing” from among analysis data 21a, 21b . . . of other users P1, P2, . . . stored in the storage. Then, recommender 7 compares analysis data 21a1, 21b1, . . . corresponding to the taste sensation information “refreshing”, with analysis data 16a of the user.

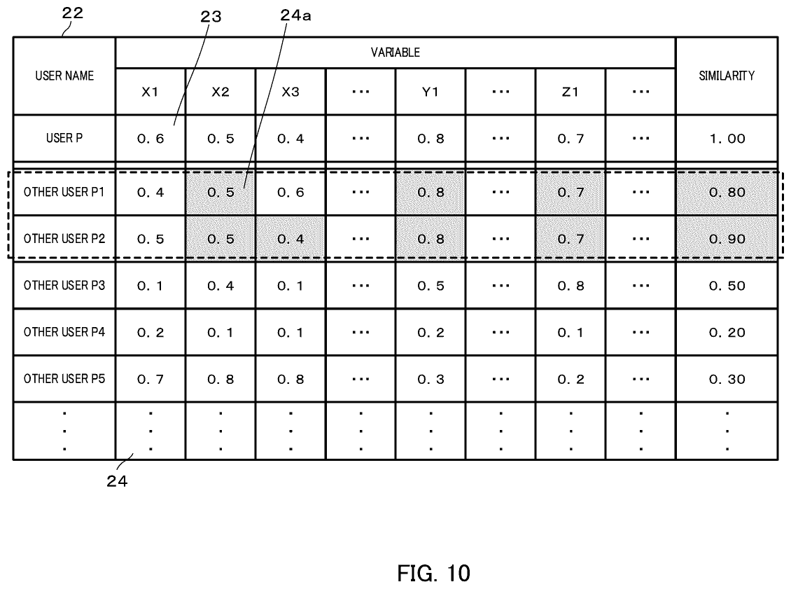

At this time, recommender 7 may search for the dish candidate to be suggested to the user from analysis data 21a1, 21b1, . . . including the eating habits corresponding to the taste sensation information “refreshing” of the other user on the basis of characteristic index 17 representing the eating habits corresponding to the specific taste sensation information “refreshing” input from the user. For example, as illustrated in FIG. 10, recommender 7 may search for the dish candidate to be suggested to user P by comparing variable value 23 of user P (characteristic index) and variable value 24 of other users P1, P2, . . . (characteristic index) with comparison data 22 by utilizing coordinate filtering. At this time, recommender 7 may calculate the similarity of variable value 24 of other users P1, P2, . . . to variable value 23 of user P for all variables X1, X2, . . . , Y1, . . . , Z1, . . . . As an example, recommender 7 may calculate the cosine similarity on the basis of the vector of variable value 23 of user P and the vector of variable value 24 of other users P1, P2, . . . . Then, recommender 7 selects the other user with a similarity equal to or greater than a predetermined value, for example other users P1 and P2 with a similarity equal to or greater than 0.8, as a user with a high similarity in eating habits to user P. Subsequently, recommender 7 counts for each of variables X1, X2 . . . the number of variable values 24a that indicate a value within a predetermined value (e.g. matching value) with respect to variable value 23 of user P from among variable values 24 of other users P1 and P2 with similar eating habits. Then, recommender 7 selects variables X2, Y1 and Z1 with a large number of variable values 24a, and outputs the dish candidate on the basis of the selected variables X2, Y1 and Z1 at step S6. At this time, recommender 7 may preferentially select the variable including event A that coincides with the name of the dish eaten by user P one or two before the reference day from among the selected variables X2, Y1 and Z1.

Note that, the method of recommender 7 for searching for the dish candidate to be suggested to the user is not limited to the coordinate filtering. For example, it is possible to search for the dish candidate to be suggested to the user by using statistics analysis, machine learning, deep learning or the like from analysis data 21a1, 21b1, . . . including the eating habits corresponding to the taste sensation information “refreshing” of the other user on the basis of characteristic index 17 representing the eating habits corresponding to the specific taste sensation information “refreshing” input from the user.

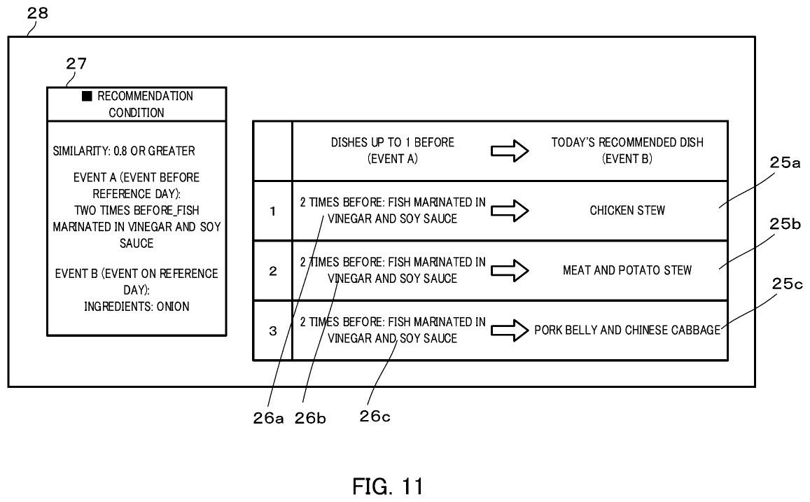

For example, as illustrated in FIG. 11, when the dishes of event B of variables X2, Y1 and Z1 are “chicken stew”, “meat and potato stew” and “pork belly and Chinese cabbage”, recommender 7 may output the dishes as dish candidates 25a to 25c. In addition, recommender 7 may output the dish of event A of variables X2, Y1 and Z1 “fish marinated in vinegar and soy sauce” as reference dishes 26a to 26c. At this time, when the dish eaten by user P two before (e.g. two days before) the reference day is “fish marinated in vinegar and soy sauce”, recommender 7 may preferentially select variables X2, Y1 and Z1 in which the dish of event A is recorded as “fish marinated in vinegar and soy sauce”. In addition, recommender 7 may output condition-related information 27 related to the condition of the selection of variables X2, Y1 and Z1. In this manner, suggestion data 28 including dish candidates 25a to 25c, reference dishes 26a to 26c, and condition-related information 27 is created.

In this manner, recommender 7 outputs dish candidates 25a to 25c to be suggested to user P on the basis of characteristic index 17 such as the support level, the probability level and the lift value. Here, characteristic index 17 is an index obtained by analyzing the characteristics of the eating habits of user P on the basis of specific event data 15a corresponding to the specific dish type information input from user P in a plurality of pieces of event data 15a, 15b . . . obtained by dividing by the dish type information the dish identification information and the dish type information and meal time information of user P at extractor 6. In this manner, recommender 7 can suggest appropriate dishes to user P.

In addition, recommender 7 analyzes the characteristics of the eating habits of other users P1, P2, . . . , and searches for dish candidates 25a to 25c on the basis of characteristic index 17 of user P and characteristic index 19 of other users P1, P2, . . . . In this manner, recommender 7 outputs dish candidates 25a to 25c on the basis of the eating habits of other users P1, P2, . . . . In this manner, recommender 7 can output various dish candidates 25a to 25c other than meal history of user P, and can reduce repetitive suggestion of dishes previously eaten by user P.

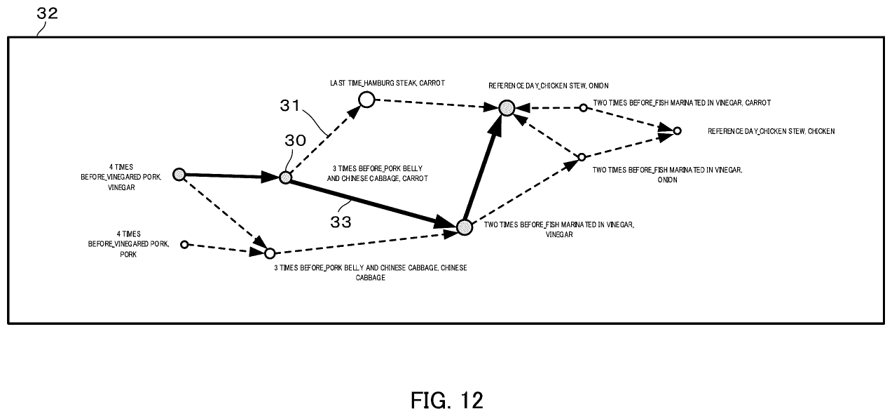

Here, recommender 7 may output information other than dish candidates 25a to 25c. For example, recommender 7 may output eating habit data representing the time relationship between event data including 15z1 and event data 15z2 including the dish identification information and the dish type information on the basis of analysis data 16a of user P output from extractor 6. In addition, recommender 7 may output eating habit data representing the time relationship between event data including 20z1 and event data 20z2 including the dish identification information and the dish type information on the basis of analysis data 21a1 and 21b1 of other users P1 and P2. For example, as illustrated in FIG. 12, recommender 7 may output eating habit data 32 that indicates as node 30 and edge 31 the time relationship between event data including 15z1 and event data 15z2 including the name of the dish (identification information) and the ingredient information on the basis of analysis data 16a of user P. Here, for example, node 30 may be formed such that the higher the support level or the frequency of selection of event data 15z2 of event B, the larger the size. In addition, edge 31 may be formed such that the greater the lift value or the probability level, the greater the thickness. At this time, recommender 7 may create eating habit data 32 only for a predetermined number of edges 31 with highest lift values or probability levels (e.g. only for the top 26 edges 31). Then, recommender 7 may select path 33 sequentially connected in order of the thickness of node 30 on a time-series basis for a predetermined period (e.g. four times or four days, etc.), and indicate path 33 by changing the display form.

In this manner, recommender 7 outputs eating habit data 32 representing the time relationship between event data 15z1 and 15z2 on the basis of characteristic index 17 representing the characteristics of the eating habits of user P. In this manner, unconscious eating habits of user P are visualized, and thus user P can easily understand the intention of suggestion of dish candidates 25a to 25c in the suggestion data 28.

Subsequently, recommender 7 transmits the created suggestion data 28 to terminal 1. At this time, recommender 7 may transmit eating habit data 32 to terminal 1. When receiving suggestion data 28 and eating habit data 32, terminal 1 displays suggestion data 28 and eating habit data 32 on the display.

According to the present embodiment, extractor 6 acquires in advance a plurality of pieces of event data 15a, 15b . . . obtained by dividing by the dish type information the dish identification information and the dish type information and meal time information of user P, and when the specific dish type information is input from user P, it extracts characteristic index 17 obtained by analyzing the characteristics of the eating habits of user P on the basis of specific event data 15a corresponding to the specific dish type information. Then, recommender 7 outputs dish candidates 25a to 25c to be suggested to user P on the basis of characteristic index 17. In this manner, recommender 7 can suggest appropriate dishes to user P.

Note that, in the present embodiment, recommender 7 outputs dish candidates 25a to 25c on the basis of the eating habits of other users P1, P2, . . . , but this is not limitative as long as dish candidates 25a to 25c can be output. For example, recommender 7 may select dish candidates 25a to 25c from analysis data 16a representing the eating habits of user P on the basis of characteristic index 17. For example, recommender 7 may select dish candidates 25a to 25c in descending order of the value of characteristic index 17 in analysis data 16a.

In addition, in the present embodiment, dish recommendation system 3 is disposed in server 2, but this is not limitative as long as the dish candidate can be output. For example, dish recommendation system 3 may be disposed in terminal 1.

In addition, while the present embodiment uses dish names or ingredient names of Japanese food for the sake of description of the present disclosure, this is not limitative. For example, the dish names or ingredient names may be changed in accordance with the food culture of the country where the dish recommendation system, the dish recommendation method and the program are used.

The specific examples of the present disclosure have been described in detail above, but these are examples only and do not limit the scope of the claims. The technology described in the claims includes various variations and modifications of the specific examples illustrated above.

This application is entitled to and claims the benefit of Japanese Patent Application No. 2023-051620 filed on Mar. 28, 2023, the disclosure each of which including the specification, drawings and abstract is incorporated herein by reference in its entirety.

### INDUSTRIAL APPLICABILITY

The dish recommendation system according to the present disclosure is applicable to systems that suggest dish candidates to the user.

### REFERENCE SIGNS LIST

1 Terminal
2 Server
3 Dish recommendation system
4 Acquirer
5 Storage
6 Extractor
7 Recommender
11 Storage device
12 Processor device
13 UI device
14 Communication device
15a, 15b Event data
16, 16a Analysis data
17 Characteristic index
18a, 18b Event data
21a, 21b Analysis data
22 Comparison data
23 Variable value
24 Variable value
25a to 25c Dish candidate
26a to 26c Reference dish
27 Condition-related information
28 Suggestion data
30 Node
31 Edge
32 Eating habit data
33 Path
P User
P1, P2 Other user

1. A dish recommendation system comprising:
an acquirer that acquires in advance a plurality of pieces of event data obtained by dividing, by dish type information, dish identification information on a dish a user has eaten, dish type information including taste sensation information that classifies the dish by taste sensation, and meal time information;
an extractor that extracts a specific characteristic index obtained by analyzing characteristics of eating habits of the user from a plurality of characteristic indices based on specific event data corresponding to specific dish type information input from the user, by calculating the plurality of characteristic indices through time-series association analysis for each dish type information based on the plurality of pieces of event data, the plurality of characteristic indices including at least one of a support level, a probability level and a lift value related to the eating habits of the user; and
a recommender that outputs a dish candidate to be suggested to the user based on the specific characteristic index.

2. The dish recommendation system according to claim 1, wherein the taste sensation information includes onomatopoeia information representing the taste sensation.

3. The dish recommendation system according to claim 1, wherein the plurality of pieces of event data includes ingredient information on the dish the user has eaten.

4. The dish recommendation system according to claim 3, wherein the plurality of pieces of event data includes at least one of the dish identification information and the ingredient information, and the dish type information that are associated with each other.

5. The dish recommendation system according to claim 1, wherein the extractor extracts the specific characteristic index by further using at least one of avoided ingredient information and preference information of the user.

6. The dish recommendation system according to claim 1, wherein the recommender analyzes characteristics of eating habits of another user, and searches for the dish candidate based on the specific characteristic index of the user and a characteristic index of the another user.

7. The dish recommendation system according to claim 1, wherein the recommender further outputs eating habit data that represents a time relationship of the specific event data by using a node and an edge based on the specific characteristic index.

8. A dish recommendation method comprising:
acquiring in advance a plurality of pieces of event data obtained by dividing, by dish type information, dish identification information on a dish a user has eaten, dish type information including taste sensation information that classifies the dish by taste sensation, and meal time information;
extracting a specific characteristic index obtained by analyzing characteristics of eating habits of the user from a plurality of characteristic indices based on specific event data corresponding to specific dish type information input from the user, by calculating the plurality of characteristic indices through time-series association analysis for each dish type information based on the plurality of pieces of event data, the plurality of characteristic indices including at least one of a support level, a probability level and a lift value related to the eating habits of the user; and
outputting a dish candidate to be suggested to the user based on the specific characteristic index.

9. A program that causes a computer to execute:
acquiring in advance a plurality of pieces of event data obtained by dividing, by dish type information, dish identification information on a dish a user has eaten, dish type information including taste sensation information that classifies the dish by taste sensation, and meal time information;
extracting a specific characteristic index obtained by analyzing characteristics of eating habits of the user from a plurality of characteristic indices based on specific event data corresponding to specific dish type information input from the user, by calculating the plurality of characteristic indices through time-series association analysis for each dish type information based on the plurality of pieces of event data, the plurality of characteristic indices including at least one of a support level, a probability level and a lift value related to the eating habits of the user; and
outputting a dish candidate to be suggested to the user based on the specific characteristic index.
